(19) United States
(12) Patent Application Publication
(10) Pub. No.: US 2025/0240850 A1
(43) Pub. Date: Jul. 24, 2025

(54) FRESH-AIR HEAT EXCHANGER AND METHOD FOR PROVIDING HEATED FRESH AIR WITH THE ELECTRICALLY HEATED FRESH AIR HEAT EXCHANGER

(71) Applicant: DÜRR SYSTEMS AG, Stuttgart (DE)

(72) Inventors: Oliver IGLAUER-ANGRIK, Stuttgart (DE); Kevin WOLL, Heilbronn (DE)

(21) Appl. No.: 18/849,376

(22) PCT Filed: May 23, 2023
(86) PCT No.: PCT/DE2023/100376

§ 371 Date: Sep. 20, 2024

(30) Foreign Application Priority Data
May 24, 2022 (DE) 10 2022 113 099.1

(51) Int. Cl. H05B 3/02; F26B 21/00

(52) U.S. Cl. CPC H05B 3/02; F26B 21/002; F26B 2210/12

(57) ABSTRACT

The present invention relates to a fresh air heat exchanger (100) for heating a fresh air stream, comprising: at least one ventilator (106) for suctioning in fresh air and generating a fresh air stream; and at least one electrically heated heat transfer unit (108) for transferring thermal energy to the fresh air stream.

### RELATED APPLICATION

This application is a national phase of international application No. PCT/DE2023/100376 filed on May 23, 2023, and claims the benefit of German application No. 10 2022 113 099.1 filed on May 24, 2022, which are incorporated herein by reference in their entirety and for all purposes.

### FIELD OF DISCLOSURE

The present disclosure relates to a fresh air heat exchanger and to a method for providing heated fresh air by means of a corresponding fresh air heat exchanger.

### BACKGROUND

It is known from practice that within treatment plants of workpieces, in particular within drying plants (dryers for short) for vehicle bodies, fresh air heaters are used which heat the fresh air supplied to the lock regions of such a plant in order to avoid condensate formation in particular in the lock regions of the plant.

The two possibilities below are generally known with regard to the heating of such fresh air heaters.

Firstly, in dryers with recuperative thermal exhaust air purification (TAR), the clean gas enthalpy flow can be used close to the dryer for the heating of the fresh air, i.e. the heat energy of the clean gas routed from the TAR is transferred to the fresh air supplied to the dryer.

Secondly, in the case of burner heating, the fresh air can be heated either directly, i.e. for example by means of a gas surface burner, or indirectly by means of a combustion chamber with flue gas heat exchanger.

As is known, a corresponding fresh air heater accordingly comprises the following components: a drawing-in means with filter, the drawing-in being effected for example directly from the hall of the dryer; a sound damper; a heat exchanger for transferring the heat energy of the clean gas to the supplied fresh air or a combustion chamber for burning a burner gas with supplied fresh air; a fan; and the required fresh air and clean gas ducts.

Here, the fresh air heater can either be integrated into a housing or be free-standing, wherein, in the latter embodiment, the individual components are connected by means of a duct system.

On the one hand, such fresh air heaters can be arranged on a separate steel platform above the dryer. In rare cases, an arrangement below the dryer is also possible, wherein the dryer tunnel itself is then mounted on a steel construction.

On the other hand, in the case of clean gas heating, an arrangement of the fresh air heater at the start or end of the clean gas train, i.e. at the start or end of the dryer, is possible, in particular in order to lower the temperature of the clean gas to a low temperature level with the aid of the supplied fresh air before said clean gas is discharged into the atmosphere, i.e. preferably led out of the hall to the outside via the roof. For lowering the temperature of the clean gas by way of the supplied fresh air, use is preferably made of a counterflow heat exchanger.

In a burner-heated dryer, the exhaust air is usually cleaned in a gas-operated regenerative thermal exhaust gas purification plant, which is also referred to as regenerative thermal oxidation (RTO). However, on account of its construction with generally three chambers and the associated dimensions, such a plant is designed for setting up outside the building, i.e. the hall. In most cases, use of waste heat for preheating the supplied fresh air is thus not applicable on account of the required duct lengths between the RTO and the fresh air heat exchanger.

Furthermore, a compact construction is not possible on account of the voluminous clean gas heat exchanger or the voluminous combustion chamber.

A corresponding plant also requires two isolated ducts or duct systems for the heating medium and the fresh air.

There are also restrictions with regard to the set-up possibilities. For instance, an additional steel platform is required in the case of an arrangement above the dryer. Irrespective of the set-up location, an isolated fresh air duct is additionally always required to run over the entire dryer length at least once, particularly if both locks (admission and discharge) have to be connected proceeding from the fresh air heat exchanger.

As already mentioned, the fresh air heated in the fresh air heater is supplied to the dryer, specifically to the lock regions of the dryer and to the recirculated air units or the recirculated air modules of those portions of the dryer in which the workpieces are treated or dried.

A dryer generally has an admission lock at the (end-side) inlet of the dryer and a discharge lock at the (end-side) outlet of the dryer, wherein the dryer generally comprises a plurality of portions which are arranged in succession and together form a treatment duct. In addition, intermediate locks can also be arranged between the treatment portions of the dryer.

The admission, intermediate and discharge locks can be of one-stage design; the admission and discharge locks can alternatively also be of two-stage design.

In the case of locks of one-stage design, a constant fresh air volume flow is led into these locks in each case with the aid of a duct proceeding from the fresh air heater.

With the aid of further ducts and corresponding branch lines to the individual recirculated air units, a variable fresh air volume flow is also led into the recirculated air units.

A fresh air regulating flap is used in this connection to regulate the fresh air quantities such that variable fresh air proportions are supplied to the recirculated air units in dependence on the dryer capacity utilization, whilst a constant fresh air proportion is always supplied to the locks. This is because in the case of low dryer capacity utilization, in relation for example to paint dryers, less solvent escapes from the painted surfaces of the workpiece to be dried. The total quantity of fresh air input into the dryer or the variable proportion supplied to the recirculated air units can also be correspondingly lower.

In the case of admission and/or discharge locks of two-stage design, i.e. locks at the end side of the dryer with a doubled, silhouette-based air curtain, the respective outer air curtain or the outer stage is supplied via a dedicated duct with fresh air heated in the fresh air heater (fresh air curtain), whereas the respective inner air curtain or the inner stage is supplied with recirculated air from the adjoining recirculated air unit (recirculated air curtain). Here, “adjoining” means that the inner stage of the discharge lock is supplied with recirculated air from the last treatment portion of the dryer, that is to say the last holding zone, or the inner stage of the admission lock is supplied with recirculated air from the first treatment portion of the dryer, that is to say the first heating zone.

In other words, the fresh air curtain can be considered to be a barrier which on its outwardly facing side adjoins a colder region. Thus, the fresh air curtain of an admission lock preferably forms a barrier between the surroundings of the treatment space and the recirculated air curtain of the admission lock, whereas the fresh air curtain of a discharge lock preferably forms a barrier between a cooling zone arranged downstream of the treatment space and the recirculated air curtain of the discharge lock.

In the context of the fresh air/exhaust air concept already presented, in the case of two-stage locks, the inner stage, i.e. the respective recirculated air curtain, is not influenced directly by the flap regulation, i.e. the supplied recirculated air proportion remains constant. The air proportions are thus adapted only for the fresh air supplied by the fresh air heater, the proportion for the outer stage, i.e. the fresh air curtain, also being kept constant here, whereas the proportion for the recirculated air units is or can be adapted by an apportioning regulating flap in dependence on the capacity utilization of the dryer.

A disadvantage of past variable fresh air/exhaust air regulation is that this approach requires two isolated fresh air ducts, specifically a lock duct for a constant fresh air proportion and an isolated unit duct for the variable fresh air proportion, both in the case of clean gas heating and burner heating. These ducts must be led to the other end of the dryer-generally to the admission lock. This corresponds in the case of a 30 JPH dryer to a duct length of 15 vehicle lengths and in the case of a 60 JPH dryer accordingly to a duct length of 30 vehicle lengths.

In addition to this, due to the supply of the variable fresh air proportion to the recirculated air units, this proportion of the fresh air does not contribute to lowering the solvent concentration in the lock region and thus also not to minimizing the risk of condensation of same in the cold edge regions of the dryer, such as in the admission region or in the cooling zones.

### SUMMARY

The present disclosure is therefore based on the object of providing a fresh air heat exchanger for heating a fresh air flow, which, by way of a more compact design, enables a more flexible and more economical arrangement in the dryer plane.

This object is achieved according to examples disclosed herein in that a fresh air heat exchanger for heating a fresh air flow is provided, comprising the following:
at least one fan for drawing in fresh air and generating a fresh air flow, and
at least one electrically heated heat transfer unit for transferring heat energy to the fresh air flow.

It is advantageous if the fresh air to be heated is preheated in a preheating apparatus before being supplied.

This approach is economical and sustainable particularly if waste heat of the dryer or regenerative energy sources are used for this purpose, since this can reduce the need for flow with a high energy quality (exergy).

This can be realized by an electrical and thus flameless plant for the regenerative thermal oxidation of the dryer exhaust air. In contrast to a gas-heated RTO (see above), the electric RTO can, on account of its construction (single bed), be set up within the building and thus close to the dryer. This procedure makes it possible to preheat fresh air by means of a clean gas enthalpy flow subsequent to the electric RTO. The electric RTO has the particular feature of a low temperature swing of about 20 K during the thermal oxidation. The enthalpy flow of the clean gas is generally not sufficient to bring the fresh air to the desired target temperature solely with the aid of a heat exchanger which transfers the heat energy of the clean gas to the fresh air. By contrast, the combination of preheating the fresh air and subsequently electrically increasing the temperature in the fresh air heat exchanger according to examples disclosed herein allows the target temperature to be efficiently achieved.

A heat pump can also be used to preheat the fresh air. In this form of preheating, a low quantity of no longer usable waste heat (for example cooling zone exhaust air with a temperature in the range from, for example, 40° C. to 50° C. or the remaining clean gas enthalpy flow after the RTO with a temperature in the range from, for example, 60° C. to 100° C.) is brought to a temperature level that can be used for preheating the fresh air using mechanical drive energy. The heat exchange between the heat pump and the fresh air or the clean gas can, for example, be effected by way of a water-air heat exchanger.

However, heat-absorbing direct evaporation on the evaporator side or heat-dissipating direct condensation on the condenser side is also possible by virtue of heat energy being supplied to, or this heat energy being discharged from, the working gas via a heat exchanger and thus without an intermediate medium.

Furthermore, solar thermal energy can be used for the preheating. The heat exchange between the fresh air and the solar thermal heat transfer medium (for example thermal oil or water) is effected, for example, by way of a water-air heat exchanger or oil-air heat exchanger.

A fresh air heat exchanger according to examples disclosed herein has the advantage that a simplified duct guide system can be achieved within the treatment plant or within the dryer owing to the omission of the heating medium, since only the duct guide system for the fresh air is still required. It is also possible to realize a reduced depth and length of the entire heat exchanger compared with a clean gas heat exchanger with combustion chamber concept. Due to the compact construction, it is advantageously possible for integrated installation in a recirculated air unit or in a lock or a lock module to be effected. It is for example also possible to use the previously unused intermediate space between the dryer outer wall and the dryer inner wall (useful space wall) for arrangement of the fresh air heat exchanger according to examples disclosed herein.

In contrast to the prior art, the compact construction of the fresh air heat exchanger makes it possible to arrange the latter in the tunnel plane, that is to say in the plane of the treatment portions of the dryer, preferably in the niches between two recirculated air units. Consequently, no additional steel construction is required.

Since the fresh air heat exchanger according to examples disclosed herein no longer needs to be set up at the end of the clean gas train, a division of the heat exchanger is advantageously possible, i.e. a separate fresh air heat exchanger for admission lock and discharge lock. An isolated fresh air duct is thus preferably not required over the entire dryer length.

In the case of an intermediate lock, the latter can also be supplied with electrically heated fresh air from the fresh air heat exchanger of the admission lock or of the admission lock unit. In this context, the temperature of the fresh air heated in the fresh air heat exchanger is adjusted to the intermediate lock, the heated fresh air flow is divided and correspondingly cold fresh air for the admission lock is added to the heated fresh air flow.

Provision is also made for the at least one electrically heated heat transfer unit to comprise at least one heating resistance device.

The electrically heated heat transfer unit, which is also referred to as register, preferably comprises, as heating resistance device, heating rods with a profile tube surrounding the heating wire. This results in a low dirt adhesion and at the same time a good cleaning possibility.

As an alternative, open, electrically insulated wire coils with high temperature resistance may be used. The fresh air flow thus flows directly over the heating wire; in this way, maximum heat transfer efficiency is achieved. This alternative is an inexpensive variant in comparison to the heating rods with profile tube.

In one embodiment of examples disclosed herein, provision is made for the at least one electrically heated heat transfer unit to be arranged downstream of the at least one fan.

Provision may also be made for the fresh air heat exchanger to have at least one filter unit for filtering the drawn-in fresh air.

Since the fresh air is drawn in for example from the hall surrounding the dryer, filtering of the drawn-in is advantageous in order to prevent contamination in particular of the heating resistance device. Filtering is sufficient at this point since the drawn-in fresh air has not yet come into contact with the dryer atmosphere.

In a further embodiment of examples disclosed herein, provision is made for the fresh air heat exchanger to have at least one sound damper unit for reducing the sound emission of the fresh air flow.

In a further embodiment of examples disclosed herein, provision is made for the at least one filter unit and/or the at least one sound damper unit to be arranged upstream of the at least one fan.

In a further embodiment of examples disclosed herein, provision is made for the at least one filter unit and/or the at least one sound damper unit to be arranged at least partially above the at least one fan.

In a further embodiment of examples disclosed herein, provision is made for the fresh air heat exchanger to have at least two, preferably three electrically heated heat transfer units.

In a further embodiment of examples disclosed herein, provision is made for the electrically heated heat transfer units to be arranged in succession along the fresh air flow.

This makes it possible for the fresh air flow to be successively heated in order to achieve the target temperature at the latest when passing through the last heat transfer unit.

In a further embodiment of examples disclosed herein, provision is made for a first flow path of the fresh air flow upstream of the fan to be perpendicular to a second flow path of the fresh air flow downstream of the fan.

The fresh air guide system on the suction side of the fan, i.e. upstream of the fan, is used to draw in the fresh air via the filter units and through the subsequent sound damper units and can be referred to as first flow path, which follows a U shape from the filter units via the sound damper units up to the fan. In relation to the set-up plane of the dryer, the fresh air flow runs horizontally from the drawing-in means via the filter units up to the sound damper units. The flow subsequently runs vertically through the sound damper units before it then flows as a horizontal flow into the fan.

The fresh air guide system on the pressure side of the fan, i.e. downstream of the fan, is effected in the longitudinal direction of the housing and thus preferably-when set up between two recirculated air units in the dryer tunnel plane-in or counter to the conveying technology direction or conveying direction of the workpieces. The flow course downstream of the fan can be considered to be the second flow path. Here, the fresh air preferably flows rectilinearly and parallel to the dryer set-up plane through the heat transfer units; in other words, the fresh air is not repeatedly deflected as in the case of a cross-counterflow heat exchanger. Thus, no deflection spaces are required, which would require additional installation space perpendicular to this air guiding direction.

The planes of the first and of the second flow path or the flow paths are preferably perpendicular to one another.

Further preferably, the second flow path runs at least approximately in or counter to the conveying direction of the treatment plant or of the treatment space.

In a further embodiment of examples disclosed herein, provision is made for the at least one fan to be a radial fan.

A radial fan transforms the upstream fresh air flow in relation to its flow direction into a downstream fresh air flow which runs perpendicular to the former. The radial compressor accordingly has the effect that the first flow path runs perpendicular to the second flow path.

In a further embodiment of examples disclosed herein, provision is made for the fresh air heat exchanger to comprise a housing in which the at least one filter unit, the at least one sound damper unit, the at least one fan and the at least one electrically heated heat transfer unit are at least partially received.

In a further embodiment of examples disclosed herein, provision is made for the housing to comprise a service side having at least one maintenance access.

The object is also achieved by the use of a fresh air heat exchanger according to examples disclosed herein as described above for heating a fresh air flow which is supplied to a treatment plant for workpieces, in particular to a drying plant for vehicle bodies.

The object is also achieved according to examples disclosed herein by a method for providing heated fresh air by means of an electrically heated fresh air heat exchanger, wherein the method comprises the following steps:
drawing in fresh air from the surroundings of the fresh air heat exchanger,
filtering the drawn-in fresh air,
reducing the sound emission of the drawn-in fresh air,
deflecting the flow direction of the fresh air flow and compressing the fresh air flow,
transferring heat energy, which is generated by at least one heating resistance device, to the fresh air flow, and
discharging the heated fresh air.

The fresh air from the surroundings of the fresh air heat exchanger is drawn in by a fan and cleaned of contaminants in the ambient air on the inlet side when flowing through at least one filter unit.

The sound emission is subsequently reduced within a sound damper unit.

Then, the fresh air flow is led through a fan, preferably a radial fan, which compresses the fresh air flow and deflects it in a direction which is perpendicular to the upstream direction of the fresh air flow.

After this, the fresh air flow flows around at least one electrically heated heat transfer unit, which each have a heating resistance device.

Lastly, the heated fresh air is discharged from the fresh air heat exchanger in the direction of the locks of the dryer.

In a further embodiment of examples disclosed herein, provision may be made for the method according to examples disclosed herein to comprise a step of preheating the fresh air in a preheating apparatus, wherein the preheating apparatus is a heat pump, a regenerative thermal, in particular purely electrically operated and flameless, oxidation apparatus or a solar thermal energy apparatus comprising thermal oil or water.

The heated fresh air is then used in a treatment plant for workpieces, in particular a drying plant for vehicle bodies, or provided to said plant so that the locks of this treatment plant can be supplied with heated fresh air.

A corresponding treatment plant for treating workpieces, in particular vehicle bodies, comprises a treatment space which itself comprises a plurality of treatment space portions, which are each assigned to one of a plurality of separate recirculated air modules of the treatment plant, and at least one lock. The lock may have a first stage and a second stage, wherein the first stage of the lock can be supplied with fresh air, and wherein the second stage can be supplied with recirculated air and/or fresh air.

Provision is made for the treatment plant to further comprise at least one electrically heated fresh air heat exchanger according to examples disclosed herein which provides heated fresh air to the at least one lock.

The use of a fresh air heat exchanger according to examples disclosed herein allows separate fresh air heat exchangers to be used for the admission lock and discharge lock, wherein the heat exchangers provide the first stage (fresh air curtain or silhouette) with a constant quantity of fresh air and the respective second stage (recirculated air silhouette or recirculated air and fresh air silhouette) with a variable quantity of fresh air.

This has the advantage that—in particular in the case of these double-stage locks—an isolated fresh air duct for the constant lock air is not required over the entire dryer length. Equally, an isolated fresh air duct for the variable air to the recirculated air units is no longer required over the entire dryer length, since now all of the fresh air is used in the region of the lock.

It is also conceivable for at least one throttle device which can be controlled and/or regulated to be arranged between the electrically heated fresh air heat exchanger and the first stage of the at least one lock, with the result that the first stage of the lock can be supplied with a constant volume flow of fresh air.

Furthermore, at least one further throttle device which can be controlled and/or regulated can be arranged between a treatment space portion and the second stage of the at least one lock, with the result that the second stage of the lock can be supplied with a constant volume flow of recirculated air and/or fresh air.

The first throttle device assigned to the first stage thus ensures the volume flow to the first stage, in that the excess proportion of fresh air is released into the train or the guide system for the second stage. The total volume flow to the second stage is regulated by way of the further, second throttle device, with the result that the second stage is also supplied with a constant volume flow.

Provision can further be made for the second stage of the lock to be assigned a lock fan. The lock fan preferably comprises a frequency converter or is controlled and/or regulated in terms of frequency.

It is also possible for the second stage of the lock to be able to be supplied with 50%, preferably 100%, particularly preferably 200%, more recirculated air than fresh air.

Provision can also be made for the first and the second stage of the lock to each be assigned a filter unit.

It is also conceivable for in each case at least one temperature sensor and at least one volume flow probe to be arranged between the at least one electrically heated fresh air heat exchanger and the at least one lock and between at least one recirculated air module and the at least one lock.

It is also possible for the second stage of the lock to be assigned a pressure sensor for the regulation of the lock fan.

Provision can also be made for the first and second stage of the lock to comprise slit nozzles for forming a silhouette-based air curtain.

In the case of an admission lock, the fan of the fresh air heat exchanger according to examples disclosed herein can thus supply the fresh air silhouette of the first stage of the lock with fresh air.

A dedicated lock fan additionally supplies the recirculated air silhouette of the second stage of the lock with recirculated air from the adjoining treatment space portion or from the adjoining heating/dryer zone.

The fresh air guide system and recirculated air guide system are connected to one another by way of a branch.

The merging point of the two guide systems opens out on the suction side of the lock fan. In this way, the lock fan can be fed both with fresh air and with recirculated air.

Arranged in both suction-side supplies, i.e. for fresh air and recirculated air, of the lock fan is a motor-driven throttle device, with the aid of which the air quantity proportions of fresh air and recirculated air for the stages of the lock can be adjusted, but with the aid of which undesired flow reversal of the lock air (fresh air and recirculated air lock) is also prevented.

The rotational speed of the fan of the fresh air heat exchanger according to examples disclosed herein, and thus the required quantity of fresh air, is dependent on the volume flow required for the drying process in a dryer. Since the quantity of air in both lock stages must be kept constant in each operating state in order to obtain an optimal lock function, the excess quantity of fresh air in the first stage is supplied via the branch of the fresh air supply to the second stage of the lock, that is to say to the recirculated air stage.

For this purpose, a volume flow probe and a temperature sensor are arranged or installed in the fresh air supply, and are used to calculate a standard volume flow. The calculated value serves as control variable for the motor-operated throttle device. It is regulated such that the fresh air flow to the first lock stage is always constant and the excess fresh air flow can be used for the second lock stage.

To ensure the constant volume flow of the second lock stage, the lock fan refers to the signal of this assigned pressure sensor. The motor-operated throttle device is regulated such that the excess fresh air flow together with the recirculated air flow produces a constant volume flow for the second lock stage.

Optionally, the lock fan may be equipped with a frequency converter. In this case, with the aid of the change in rotational speed of the fan and with the aid of the motor-operated throttle device or preferably even without the motor-operated throttle device, the volume flow can be kept constant.

Preferably, all the electrically operated heating components, such as inter alia fresh air heat exchanger, can be supplied with a mean voltage of for example at least approximately 3 kV and/or at most approximately 8 kV, in particular 4160 V to 6600 V, instead of the customary 400 V. Although this may require special heating elements with corresponding additional costs, it preferably offers large saving potential in the periphery, i.e. with respect to the connections, cables, etc. Furthermore, a substantially lower factor of the voltage transformation from the supply network is required, this inter alia reducing the size of the transformer station to the benefit of lower capital costs and saving space. The connection to an electrically operated heating component with such a mean voltage also entails considerably lower cable diameters.

Further preferred features and/or advantages of examples disclosed herein are the subject of the description below and of the diagrammatic illustration of exemplary embodiments.

### BRIEF DESCRIPTION OF THE DRAWINGS

FIG. 1 shows a schematic isometric illustration of an electrically heated fresh air heat exchanger according to examples disclosed herein;

FIG. 2 shows a schematic illustration of an end side of the electrically heated fresh air heat exchanger according to examples disclosed herein;

FIG. 3 shows a schematic illustration of a service side of the electrically heated fresh air heat exchanger according to examples disclosed herein; and

FIG. 4 shows a schematic illustration of the inlet region of a treatment plant with an electrically heated fresh air heat exchanger and an inlet-side double lock.

Identical or functionally equivalent elements are provided with the same reference signs in all of the figures.

### DETAILED DESCRIPTION OF THE DRAWINGS

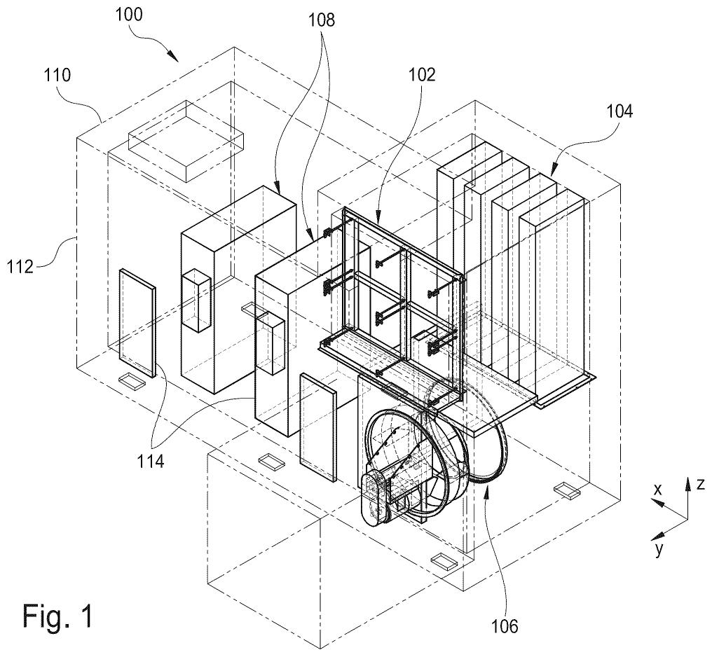

A fresh air heat exchanger 100, illustrated schematically in FIGS. 1 to 3, is used to provide a heated fresh air heat flow within a treatment plant 10 of workpieces (not illustrated).

The treatment plant 10 is for example a drying plant 12 for drying workpieces.

The workpieces are for example vehicle bodies.

In particular for the simplified description of the fresh air flow, a three-dimensional coordinate system with the axes x, y, z has been introduced into FIGS. 1 to 3.

The fresh air heat exchanger 100 comprises a filter unit 102, a sound damper unit 104, a radial fan 106 and two electrically heated heat transfer units 108, which are together received in a housing 110.

The housing 110 has a service side 112, in which two maintenance accesses 114 are provided.

The filter unit 102 and the sound damper unit 104 are arranged above the radial fan 106.

In the exemplary embodiment in FIG. 1, the sound damper unit 104 comprises four cuboid sound damper elements.

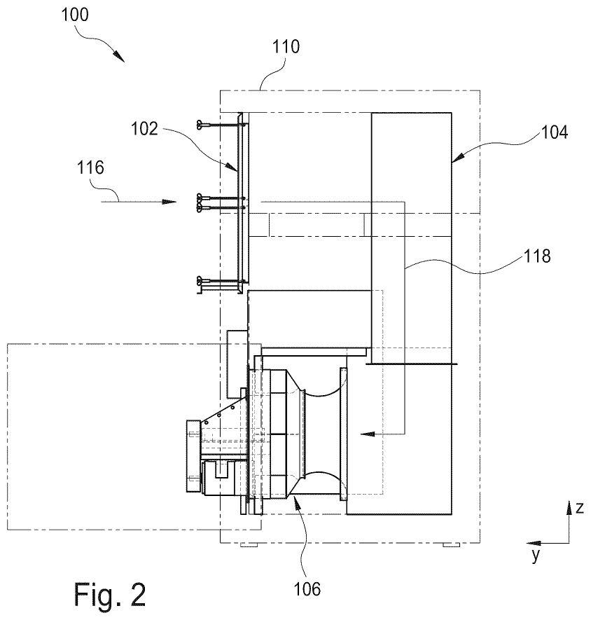

It can be seen in FIG. 2 that the drawn-in fresh air 116, which is preferably drawn in from the surrounding hall, first flows through the filter unit 102 in the y direction, i.e. in a horizontal direction, in order to filter possible contaminants out of the drawn-in fresh air 116.

The drawn-in fresh air 116 may be ambient air, i.e. from inside or outside the hall in which the treatment plant 10 is installed, or alternatively cleaned exhaust air.

On the upstream side of the radial compressor 106, i.e. on the suction side thereof, the drawn-in fresh air 116 describes a U-shaped, first flow path in the yz plane.

Along the first flow path 118, after the filter unit 102, the fresh air flow passes through the sound damper unit 104 in the z direction, i.e. in a vertical direction.

The fresh air then flows through the radial fan 106 in the y direction, i.e. again in a horizontal direction.

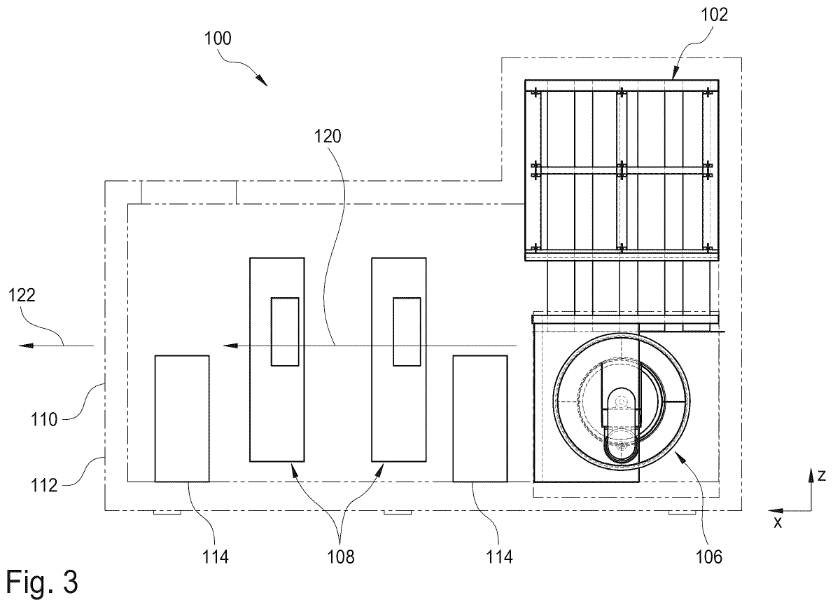

FIG. 3 illustrates that the radial fan 106 deflects the fresh air flow into the xz plane.

On the downstream side of the radial fan 106, i.e. on the pressure side, the fresh air flows in the x direction, i.e. in a horizontal direction, along a second, straight flow path 120.

After the radial fan 106, the deflected fresh air flow flows through or around the two heat transfer units 108 arranged in succession along the second flow path 120.

Here, the heat energy generated in each case by means of a heating resistance device of the electrically heated heat transfer unit 108, such as preferably a heating wire, is transferred to the fresh air flow, before said fresh air flow exits the housing 110, or is led out of said housing, as heated fresh air 122 or a heated fresh air heat flow.

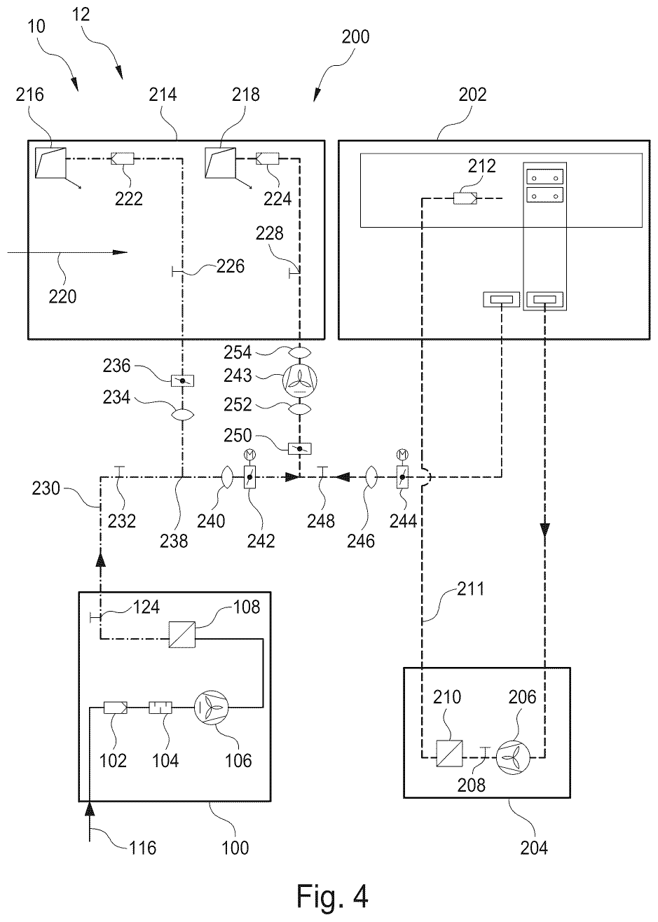

The reaching of the target temperature of the heated fresh air 122 is preferably measured or checked at the outlet of the fresh air heat exchanger 100 by means of a temperature sensor 123 and a measurement connection 124 (illustrated in FIG. 4).

Preferably, the standard volume flow at the outlet of the fresh air heat exchanger 100 is between 4250 standard m³/h and 12 000 standard m³/h for the case of a divided heat exchanger for supplying the admission lock and intermediate lock and, respectively, discharge lock. In the case of a single fresh air heat exchanger 100 for supplying all of the locks, the standard volume flow is up to 24 000 standard m³/h.

FIG. 4 schematically illustrates the inlet region of a treatment plant 10, for example a drying plant 12.

The treatment plant 10 comprises a treatment space 200 with a plurality of treatment space portions, of which a first treatment space portion 202 or a first heating zone is shown in FIG. 1.

The first treatment space portion 202 is assigned a recirculated air module 204 or a recirculated air unit.

The recirculated air module 204 comprises a recirculated air fan 206, a measurement connection for manual measurements 208 and a heat exchanger 210.

Also arranged in the first treatment space portion 202 is a filter unit 212 which filters the recirculated air recycled by the recirculated air module 204 via the recirculated air guide system 211.

Furthermore, according to the exemplary embodiment in FIG. 4, the treatment space 200 comprises a two-stage lock 214, which preferably forms a silhouette-based air curtain, in order to inter alia keep the solvent in the treatment space 200 or to prevent said solvent from being discharged to the surroundings.

The lock 214 has a first stage 216 and a second stage 218, wherein—in relation to a conveying direction 220 of the workpieces within the treatment space 200—the workpieces first pass through the first stage 216, followed by the second stage 218.

Preferably, the first stage 216 and the second stage 218 are arranged directly one behind the other in the conveying direction 220, that is to say without an intermediate element.

However, it is also conceivable in an advantageous embodiment for a pivotable shield to be able to be attached between the stages 216, 218, said pivotable shield, when pivoted out, functioning as a physical barrier which assists the lock function and simultaneously stabilizing the air flow of the first stage 216.

Each stage 216, 218 of the lock 214 is a filter unit 222, 224, in order to ensure that no contamination from the respective air supplies is applied to the workpieces via the slit nozzles (not illustrated) of the stages 216, 218 of the lock 214.

Upstream of the filter units 222, 224, each stage 216, 218 is also assigned a measurement connection for manual measurements 226, 228, via which physical variables can be manually monitored in particular during the start-up of the lock 214.

The lock 214 is supplied with heated fresh air 122 via a fresh air supply 230 from a fresh air heat exchanger 100, as has been described above in connection with FIGS. 1 to 3.

The fresh air supply 230 firstly routes the heated fresh air 122 to the first stage 216, which forms a fresh air curtain.

A further measurement connection for manual measurements 231, a compensator 232 and a throttle device 233 are arranged in the flow path of the fresh air supply 230 toward the first stage 216 of the lock 214, which is supplied with a constant fresh air volume flow, preferably in the amount of 4250 standard m³/h. The compensator 232 is an element for compensating for movements in the corresponding pipe of the fresh air supply 230, in particular in the case of thermal changes in length, vibrations, wall feedthroughs or settling phenomena.

Arranged upstream of the throttle device 233 and downstream of the measurement connection 226 is a temperature sensor 234 and a volume flow probe 236, in particular a dynamic pressure probe.

Furthermore, the fresh air supply 230 is branched off at a branch 238 in the direction of the second stage 218, in order to also be able to supply the second stage 218 with fresh air.

Arranged downstream of the branch 238 is a further compensator 240 and a motor-driven throttle device 242, which can be controlled and/or regulated.

By means of the motor-driven throttle device 242, the quantity of fresh air which can be supplied to the second stage 218 can be adjusted, i.e. controlled and/or regulated.

The second stage 218 is fundamentally supplied with recirculated air from the first treatment space portion 202, said recirculated air being drawn in by means of a lock fan 243.

In other words, the lock fan 243 supplies the recirculated air silhouette of the second stage 218 with recirculated air from the adjoining, first processing portion 202.

The quantity of recirculated air is also controlled and/or regulated by a motor-driven throttle device 244.

A further compensator 246 and a further measurement connector for manual measurements 248 are arranged downstream of the motor-driven throttle device 244, before the branched-off fresh air flow is supplied to the recirculated air flow.

The second stage 218 of the lock 214 also forms an air curtain by way of a constant volume flow, preferably in the amount of 10 000 m³/h at operating pressure, comprising recirculated air and fresh air.

Arranged downstream of the fresh air supply 230 in the recirculated air flow is a further throttle device 250 for setting the volume flow.

Furthermore, to compensate for pipe movements in the region of the lock fan 243, a further compensator 252 and, respectively, 254 is arranged directly upstream and downstream of the lock fan 243.

The rotational speed of the radial compressor 106 of the fresh air heat exchanger 100, and thus the required or supplied quantity of fresh air, is dependent on the air mass flow rate required for the treatment process or the drying process. Since in particular the quantity of fresh air in the first stage 216 of the lock 214 must be kept constant in order to obtain an optimal lock function, the excess quantity of fresh air is supplied via the branch 238 to the second stage 218, that is to say to the recirculated air stage.

For this reason, the temperature sensor 234 and the volume flow probe 236 are provided in the fresh air supply 230. These two measuring devices can be used to determine the (standard) volume flow, which is used as control variable for the motor-driven throttle device 242. This throttle device 242 can be regulated such that the fresh air flow to the first stage 216 is always constant and the excess proportion of fresh air is routed to the second stage 218.

Arranged before the lock slit or the lock nozzle of the second stage 218 and in particular after the filter unit 224 is a pressure sensor 256, the pressure difference of which in relation to the surroundings, such as the hall, is used as control variable for the frequency-regulated lock fan 243. By way of this differential pressure, it is also ensured that a constant air flow is also applied to the second stage 218. The arrangement after the filter unit 224 ensures that the soiling of the filter unit 224 is irrelevant for the pressure measurement.

As already mentioned, this air flow can consist of pure recirculated air or alternatively of a mixture of recirculated air and fresh air.

If the drying process is run with a high quantity of fresh air, i.e. a high dryer capacity utilization, the excess proportion of fresh air is correspondingly high, preferably at most up to 7500 standard m³/h. As a result, the added proportion of recirculated air for the second stage 218 is lower.

It is the other way round in the case of a low capacity utilization when only a few workpieces such as vehicle bodies are located in the drying plant 12, i.e. a low dryer capacity utilization. Here, the quantity of fresh air provided on the part of the fresh air heat exchanger is sufficient to supply the first stage 216 of the lock 214 with fresh air.

In this case, the motor-driven throttle device 242 is entirely or largely closed and the air for the second stage 218 must be drawn in completely by means of the lock fan 243 from the adjacent first treatment space portion 202.

The supply of the excess proportion of fresh air to the second stage 218 in dependence on the capacity utilization of the treatment plant 10 has the advantage that fresh air is no longer added directly to the recirculated air modules 204 as previously, which has the effect that all the fresh air in the lock 214 is available to contribute there to reducing the solvent content in the atmosphere of the treatment space 200 at the edge regions thereof to a minimum. In this way, the risk of solvent recondensation in these cooler edge regions is even more effectively counteracted.

### LIST OF REFERENCE SIGNS

10 Treatment plant
12 Drying plant/dryer
100 Fresh air heat exchanger
102 Filter unit
104 Sound damper unit
106 Radial fan
108 Heat transfer unit
110 Housing
112 Service side
114 Maintenance access
116 Drawn-in fresh air
118 First flow path
120 Second flow path
122 Heated fresh air
123 Temperature sensor
124 Measurement connector for manual measurements
200 Treatment space
202 Treatment space portion/first heating zone
204 Recirculated air module/recirculated air unit
206 Recirculated air fan
208 Measurement connector for manual measurements
210 Heat exchanger
211 Recirculated air guide system
212 Filter unit
214 Two-stage lock
216 First stage of the lock
218 Second stage of the lock
220 Conveying direction
222 Filter unit
224 Filter unit
226 Measurement connector for manual measurements
228 Measurement connector for manual measurements
230 Fresh air guide system
231 Measurement connector for manual measurements
232 Compensator
233 Throttle device
234 Temperature sensor
236 Volume flow probe
238 Branch
240 Volume flow probe
242 Motor-driven throttle device
243 Lock fan
244 Motor-driven throttle device
246 Compensator
248 Measurement connector for manual measurements
250 Throttle device
252 Measurement connector for manual measurements
254 Measurement connector for manual measurements
256 Pressure sensor

1. A fresh air heat exchanger for heating a fresh air flow, comprising:
at least one fan for drawing in fresh air and generating a fresh air flow, and
at least one electrically heated heat transfer unit for transferring heat energy to the fresh air flow.

2. The fresh air heat exchanger as claimed in claim 1, wherein the at least one electrically heated heat transfer unit includes at least one heating resistance device.

3. The fresh air heat exchanger as claimed in claim 1, wherein the at least one electrically heated heat transfer unit is arranged downstream of the at least one fan.

4. The fresh air heat exchanger as claimed in claim 1, wherein the fresh air heat exchanger has at least one filter unit for filtering the drawn-in fresh air.

5. The fresh air heat exchanger as claimed in claim 1, wherein the fresh air heat exchanger has at least one sound damper unit for reducing the sound emission of the fresh air flow.

6. The fresh air heat exchanger as claimed in claim 5, wherein the at least one filter unit and/or the at least one sound damper unit are arranged upstream of the at least one fan.

7. The fresh air heat exchanger as claimed in claim 5, wherein the at least one filter unit and/or the at least one sound damper unit are arranged at least partially above the at least one fan.

8. The fresh air heat exchanger as claimed in claim 1, wherein the fresh air heat exchanger has at least two, preferably three electrically heated heat transfer units.

9. The fresh air heat exchanger as claimed in claim 8, wherein the electrically heated heat transfer units are arranged in succession along the fresh air flow.

10. The fresh air heat exchanger as claimed in claim 1, wherein a first flow path of the fresh air flow upstream of the fan is perpendicular to a second flow path of the fresh air flow downstream of the fan.

11. The fresh air heat exchanger as claimed in claim 1, wherein the at least one fan is a radial fan.

12. The fresh air heat exchanger as claimed in claim 5, wherein the fresh air heat exchanger includes a housing in which the at least one filter unit, the at least one sound damper unit, the at least one fan and the at least one electrically heated heat transfer unit are at least partially received.

13. The fresh air heat exchanger as claimed in claim 12, wherein the housing includes a service side having at least one maintenance access.

14. The fresh air heat exchanger as claimed in claim 1, wherein a preheating apparatus for preheating the fresh air flow is arranged upstream of the at least one fan, wherein the preheating apparatus is a heat pump, a regenerative thermal, in particular purely electrically operated and flameless, oxidation apparatus or a solar thermal energy apparatus including thermal oil or water.

15. The use of a fresh air heat exchanger as claimed in claim 1 for heating a fresh air flow which is supplied to a treatment plant for workpieces, optionally to a drying plant for vehicle bodies.

16. A method for providing heated fresh air by an electrically heated fresh air heat exchanger, the method comprising:
drawing in fresh air from the surroundings of the fresh air heat exchanger,
filtering the drawn-in fresh air,
reducing the sound emission of the drawn-in fresh air,
deflecting the flow direction of the fresh air flow and compressing the fresh air flow,
transferring heat energy, which is generated by at least one heating resistance device, to the fresh air flow, and
discharging the heated fresh air.

17. The method as claimed in claim 16, wherein the method further includes a step of preheating the fresh air in a preheating apparatus, wherein the preheating apparatus is a heat pump, a regenerative thermal, optionally purely electrically operated and flameless, oxidation apparatus or a solar thermal energy apparatus including thermal oil or water.
